(19) United States
(12) Patent Application Publication
(10) Pub. No.: US 2019/0360696 A1
(43) Pub. Date: Nov. 28, 2019

(54) Burner Tip for Fitting in a Burner with Air Duct System and Fuel Channel System

(71) Applicant: Siemens Aktiengesellschaft, München (DE)

(72) Inventors: Christoph Kiener, München (DE); Andreas Kreutzer, Berlin - Hellersdorf (DE); Matthias Salcher, München (DE); Carl Hockley, Worcester (GB); Yves Küsters, Berlin (DE)

(73) Assignee: Siemens Aktiengesellschaft, München (DE)

(21) Appl. No.: 16/472,575

(22) PCT Filed: Dec. 19, 2017
(86) PCT No.: PCT/EP2017/083495

§ 371 Date: Jun. 21, 2019

(30) Foreign Application Priority Data
Dec. 22, 2016 (DE) 10 2016 226 061.8

(51) Int. Cl. F23R 3/28; F02C 7/14; F02C 7/18; F23D 14/22

(52) U.S. Cl. CPC F23R 3/283; F02C 7/14; F02C 7/18; F23D 14/22; F23D 2212/10; F23D 2213/00; F23D 2214/00; F05D 2220/32; F05D 2260/213; F05D 2260/232; F23D 2212/20

(57) ABSTRACT

A burner tip for fitting in a burner comprising: an air duct system; a fuel channel system open to a surrounding area; and a central air duct of the air duct system running through the burner tip surrounded by a wall structure. The wall structure comprises open pores and/or a space grid. Open pores in the wall structure and/or gaps in the grid form a connection between the central air duct and the surrounding area of the burner tip.

### CROSS-REFERENCE TO RELATED APPLICATIONS

This application is a U.S. National Stage Application of International Application No. PCT/EP2017/083495 filed Dec. 19, 2017, which designates the United States of America, and claims priority to DE Application No. 10 2016 226 061.8 filed Dec. 22, 2016, the contents of which are hereby incorporated by reference in their entirety.

### TECHNICAL FIELD

The present disclosure relates to burners. Various embodiments may include a burner tip for fitting in a burner. The surrounding area of the burner tip in this case is created by a combustion chamber, for example, in which fuel conveyed through a fuel channel system is combusted. This combustion chamber may be arranged in a gas turbine, for example.

### BACKGROUND

Burner tips are described in EP 2 196 733 A1, for example. The burner tip described there may be used in a gas turbine, for example, wherein the burner tip forms the downstream end of a burner lance which is arranged in a main duct for combustion air. The burner tip has a double-walled design, wherein the outer wall forms a heat shield intended to keep the resulting combustion heat away from the inner wall. An annular cavity, in other words an annular space, is therefore arranged between the outer wall and the inner wall which can have air flowing through it for cooling purposes across openings. The heat shield in the design described must be configured to withstand the heat stress caused by the combustion taking place in the downstream combustion chamber. The outer wall of the burner tip therefore represents the limiting factor for the service life of the burner tip.

### SUMMARY

The teachings of the present disclosure describe burner tips designed in such a manner that an improvement in the service life of the component results, including methods of producing a burner tip of this kind. For example, some embodiments include a burner tip for fitting in a burner (11), wherein the burner tip has an air duct system open to the surrounding area of the burner tip and a fuel channel system open to the surrounding area of the burner tip, characterized in that an air duct (20) which is part of the air duct system runs centrally in the burner tip and this central air duct is surrounded by a wall structure (25) which is openly porous and/or configured as a space grid, wherein pores (31) located in the wall structure (25) and/or gaps in the grid (32) which are part of the air duct system form a connection between the air duct (20) and the surrounding area of the burner tip.

In some embodiments, the wall structure (25) is made up of multiple layers (26, 27, 28) of different porosity and/or a different grid structure, wherein the layers (26, 27, 28) run in succession from the air duct system.

In some embodiments, three layers (26, 27, 28) with a different porosity and/or different grid structure are provided. In some embodiments, the mean pore size in adjacent layers, viewed in the air flow direction provided, diminishes from layer to layer.

In some embodiments, the pore size of the pores (31) in a layer (26) bordering the surrounding area of the burner tip is between 10 and 250 μm or between 30 and 170 μm.

In some embodiments, the pore size of the pores (31) or the size of the grid gaps (32) in the space grid in a layer (28) adjacent to the central air duct is between 1 and 9 mm, between 2 and 6 mm, or between 2.5 and 4.5 mm.

In some embodiments, the pore size of the pores (31) in an intermediate layer (27) or multiple intermediate layers, which lies or lie between the layer (28) adjacent to the central air duct and the layer (26) bounding the surrounding area of the burner tip, is between 150 and 1000 μm, between 200 and 800 m, or between 250 and 750 μm.

In some embodiments, air-guiding structures (34) are provided in the central air duct (20). In some embodiments, the air-guiding structures (34) are fitted with inner channels (35) which are directed at the wall structure (25).

In some embodiments, the central air duct (20) leads to a central outlet opening (24) in the burner tip.

In some embodiments, the wall structure (25) has a conical or dome-shaped form.

In some embodiments, a plurality of fuel channels (36) which are part of the fuel channel system lead through the wall structure (25) and the fuel channels (36) are open to the surrounding area of the fuel tip.

In some embodiments, the fuel channels (36) are connected to an annular channel (22) surrounding the central air duct (20), which annular channel is part of the fuel channel system.

As another example, some embodiments include a method of producing a burner tip as described above, characterized in that an additive manufacturing process is used for production in which the wall structure (25) which is openly porous and/or configured as a space grid is produced with the burner tip in one piece.

In some embodiments, the wall structure (25) is produced from multiple layers (26, 27, 28) of different porosity and/or a different grid structure which run in succession from the air duct system.

In some embodiments, the burner tip is manufactured in a powder bed (39) and the porosity of the layers of different porosity is produced by changing the energy application in the powder bed (39) and/or by using different powders.

As another example, some embodiments include a burner tip for fitting in a burner (11), wherein the burner tip has an air duct system open to the surrounding area of the burner tip and a fuel channel system open to the surrounding area of the burner tip, characterized in that an air duct (20) which is part of the air duct system runs centrally in the burner tip and this central air duct is surrounded by a wall structure (25) which is openly porous and produced by an additive manufacturing process in one piece with the burner tip, wherein pores (31) located in the wall structure (25) which are part of the air duct system create a connection between the air duct (20) and the surrounding area of the burner tip.

As another example, some embodiments include a burner with a burner lance (15), characterized in that a burner tip (19) as described above is provided at the end of the burner lance (15).

### BRIEF DESCRIPTION OF THE DRAWINGS

Further details of the teachings herein are described below with the help of the drawings. Identical or corresponding drawing elements are only explained more than once insofar as there are differences between the individual figures.

In the drawings:

FIG. 1 shows the schematic design of a burner fitted in this exemplary embodiment with an example burner tip incorporating the teachings herein, in section,

FIG. 2 shows an exemplary embodiment of an example burner incorporating the teachings herein in section,

FIG. 3 shows an exemplary embodiment of an example method incorporating the teachings herein in which a burner according to FIG. 2 is manufactured, as a detail,

FIG. 4 shows another exemplary embodiment of a burner tip incorporating the teachings herein in section, and

FIG. 5 shows the detail V according to FIG. 4.

### DETAILED DESCRIPTION

In some embodiments, an air duct which is part of the air duct system runs centrally in a burner tip and this central air duct is surrounded by a wall structure which is openly porous and/or configured as a space grid, wherein pores located in the wall structure (in the case of an openly porous wall structure) and/or gaps in the grid (in the case of a wall structure configured as a space grid) form a connection between the air duct and the surrounding area of the burner tip. This connection is therefore part of the air duct system which leads to the surrounding area of the burner tip. This is achieved in the case of pores in that the wall structure is openly porous, i.e. the pores create channels which help to transport air in the air duct system. This also applies to the grid gaps which are connected to one another in such a manner that an outwards path is created for the air which is part of the air duct system.

The design of the wall structure brings with it an enlarged surface for a transfer of heat from the surrounding area of the burner tip into the air flowing in the air duct system. This produces counter-current cooling, so that heat entering after a transfer into the air is released again through the wall structure. A further cooling effect is produced in that the wall structure provides a plurality of small openings on the surface of the burner tip via the pores or grid gaps, through which openings air flows out into the surrounding area of the burner tip. An air jacket is created there which, although the air has already been heated to some extent in the wall structure, is still cooler than the combustion temperature present in the combustion chamber. In this way, the resulting air jacket creates thermal insulation and reduces the heat input and therefore the thermal load on the burner tip additionally.

In some embodiments, the wall structure may comprise multiple layers of different porosity (in the case of an openly porous wall structure design) and/or a different grid structure (in the event that the wall structure is designed as a space grid), wherein these layers run in succession from the air duct system. In particular, three layers with different porosity and/or a different grid structure may be provided. The layered structure allows the wall structure to be provided layer-by-layer with the desired properties, wherein the thermal conductivity properties, mechanical stability and flow resistance in the layers formed by the wall structure can be influenced. In some embodiments, the flow resistance are all the smaller, the greater the total cross section of the pores or grid gaps supplied. The flow resistance in the case of large pores or grid gaps is also lower than in the case of small ones. The thermal conduction in the wall structure is primarily determined by the volume fraction of material compared with the volume fraction of pores. The greater the volume fraction of material is, the greater the thermal conduction too. The mechanical stability in an openly porous material will usually be lower than in a space grid which can be optimized in terms of mechanical loads when selecting its geometry.

In some embodiments, the mean pore size in adjacent layers, viewed in the air flow direction provided, diminishes from layer to layer. In other words, the air initially flows through a layer with a larger mean pore size with a comparatively lower flow resistance, where it absorbs heat and then flows through the layer with a smaller mean pore size where it is able to absorb further heat due to the lower flow speed and greater surface area. The plurality of pores with a smaller mean size moreover brings about the reliable formation of a closed air jacket which offers additional thermal protection during an outward flow into the surrounding area of the burner tip.

In order to achieve an optimal cooling effect and the formation of an effective air jacket, the pore size of the pores in a layer bordering the surrounding area of the burner tip may be between 10 and 250 μm, or between 30 and 170 μm. In a layer adjacent to the central air duct, the pore size of pores may be between 1 and 9 mm, between 2 and 6 mm, or between 2.5 and 4.5 mm. Instead of a porous layer, a layer comprising a space grid may also be used, wherein the grid gaps may likewise be between 1 and 9 mm, between 2 and 6 mm, or between 2.5 and 4 mm. The hole spacing may also be used as a characteristic variable for the grid, wherein this is determined as the spacing of the respective focal points of the cross-sectional areas of the grid gaps from one another and may likewise lie within the value ranges indicated above.

If three layers are provided in the wall structure, the pore size of the pores in a center layer, also referred to as an intermediate layer, which lies between the layer adjacent to the central air duct and the layer bounding the surrounding area of the burner tip, may be between 150 and 1000 μm, between 200 and 800 μm, or between 250 and 750 μm. A plurality of intermediate layers may also be provided.

In some embodiments, air-guiding structures are provided in the central air duct. Air flows against these structures, as a result of which the air flow can be directed in a suitable manner. For example, it is possible for the air-guiding structures to be fitted with inner channels which are directed at the wall structure. In this way, the air flow on the side adjacent to the air duct can be provided with a uniform air flow, so that said air flow supplies all pores and/or grid gaps opening to the air duct with air.

In some embodiments, a plurality of fuel channels which are part of the fuel channel lead through the wall structure, wherein these fuel channels are connected to fuel openings in the surface of the burner tip. These fuel openings may be uniformly distributed over the periphery of the burner tip, so that the fuel is uniformly introduced into the flowing air and distributed therein. The following more uniform combustion of the fuel also means that the thermal load of the burner tip is more homogeneous, as a result of which asymmetric thermal load peaks are avoided.

In some embodiments, the fuel channels may be connected to an annular channel surrounding the central air duct, which annular channel is likewise part of the fuel channel system. In this way, fuel can be uniformly supplied to all fuel channels, so that the amount of fuel released at the different fuel openings is also homogeneous. This may result in uniform combustion of the fuel and a uniform thermal load on the burner tip.

In some embodiments, an additive manufacturing process is used for production in which the wall structure which is openly porous and/or configured as a space grid is produced with the burner tip in one piece. Additive manufacturing methods may be suitable for the production of fine grid structures too, so that the pore size can be optimally adapted to structural requirements. In particular, fine grid structures can be produced which exhibit the dimensions already mentioned above. Different porosities can also be produced in the manufactured structures, so that the wall structure can also be made of multiple layers during the additive manufacturing process. In this case, the wall structure is formed in one piece. The wall structure may also be manufactured additively in one piece with the remainder of the burner tip.

The different porosity in the layers may be produced by changing the energy application in the powder bed of a powder bed-based additive manufacturing process. Another possibility is that of using different powders. When producing the powder bed, these powders can be metered in a spatially resolved manner or consecutively and then melted. By changing the energy application, it is possible to vary between complete melting of the powder particles (selective laser melting) and sintering (selective laser sintering) of the powder particles by melting their surface, wherein with a sintering method an openly porous channel system is created between the particles.

In some embodiments, the method includes reducing the energy application by increasing the line spacing of the exposure lines. The spacing may be of such a size that some of the particles in the powder bed are not melted, as a result of which pores are created in the structure in these areas. The transition from the production of pore structures of this kind to the production of grid structures is smooth in this case because grid structures are also produced in that the powder bed material is only melted in the region where the grid bars are to be produced.

An additive manufacturing method within this application refers to a method in which the material from which a component is to be produced is added to the component during its development. This means that the component is developed in its final form or at least in a form approximating this. The construction material may be in powder form, wherein the additive manufacturing process means that the material used to manufacture the component is physically consolidated by applying energy.

So that the component can be manufactured, the data describing said component (CAD model) may be prepared for the chosen additive manufacturing process. In order to generate instructions for the production plant, the data is converted into component data adapted to the manufacturing process, so that suitable process stages for successive manufacturing of the component can be followed in the production plant. The data is prepared for this in such a manner that the geometric data for the layers of the component to be manufactured in each case are supplied, these also being referred to as slices.

Selective laser sintering (or SLS), selective laser melting (or SLM), electron beam melting (or EBM), laser metal deposition (or LMD) or gas dynamic cold spray (or GDCS) can be given as examples of additive manufacturing. These methods are suitable for the processing of metallic materials in the form of powders, with which structural components can be manufactured.

In the case of SLM, SLS and EBM, the components are manufactured layer-by-layer in a powder bed. These methods are therefore also referred to as powder bed-based additive manufacturing methods. A layer of powder is produced in the powder bed in each case, which layer is then melted or sintered locally by the energy source (laser or electron beam) in those areas in which the component is to be created. The component is therefore produced by successive layers and can be removed from the powder bed following completion.

In the case of LMD and GDCS, the powder particles are supplied straight to the surface on which material is to be deposited. In the case of LMD, the powder particles are melted by a laser right at the target point on the surface and thereby create a slice of the component being manufactured. In the case of GDCS, the powder particles are greatly accelerated so that they remain adhered to the surface of the component, primarily on account of their kinetic energy with simultaneous deformation.

GDCS and SLS have in common the feature that the powder particles are not completely melted during this process. This also facilitates, among other things, the manufacture of porous structures when gaps between the particles are retained. In the case of GDCS, melting takes place in the peripheral area of the powder particles at most, said powder particles being able to melt on account of the severe deformation of their surface. In the case of SLS, when selecting the sintering temperature, it is important to ensure that it lies below the melting temperature of the powder particles. On the other hand, in the case of SLM, EBM and LMD, the energy application is deliberately high enough for the powder particles to be completely melted.

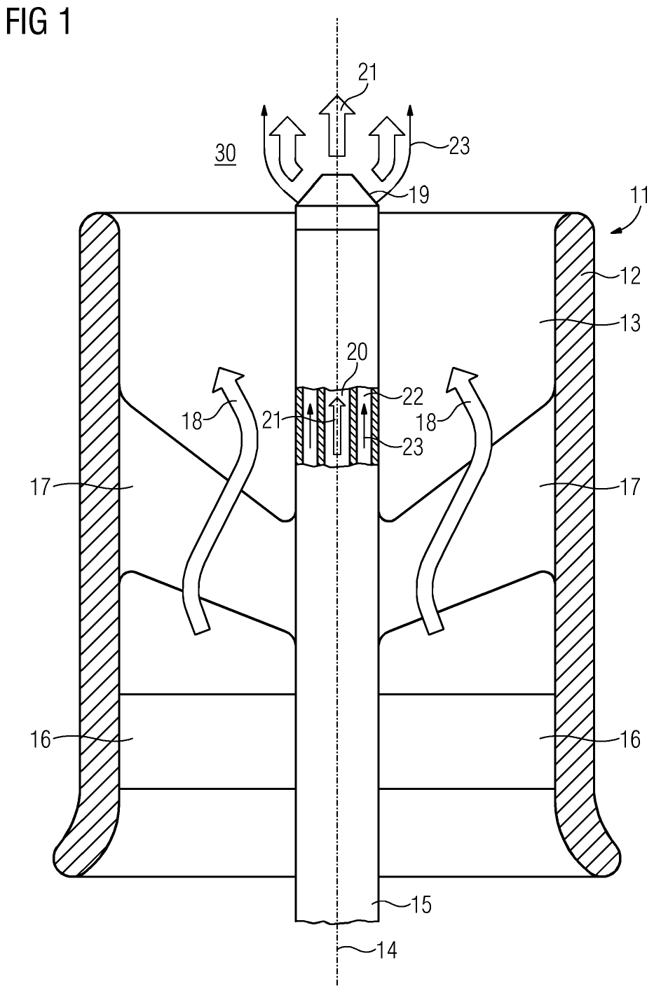

A burner 11 is depicted in FIG. 1 which has a jacket 12 in which a main duct for air 13 is formed. The jacket 13 is symmetrically constructed about an axis of symmetry 14 and has a burner lance 15 in the center of the main duct 13. The burner lance 15 is fixed in the main duct 13 with webs 16. Moreover, guide vanes 17 extend between the burner lance 15 and the jacket 12 which cause the air to spin about the axis of symmetry 14, as can be inferred from the air arrows 18 indicated.

The burner lance 15 has a burner tip 19 at the downstream end, wherein this tip is supplied with air 21 via a central air duct 20 and with fuel 23 via an annular channel 22 arranged about the air duct 20. The fuel 23 may be in gas or liquid form. The air 21 and the fuel 23 are expelled via openings in the burner tip which are not depicted in greater detail and thereby mixed with the air flow from the main duct 13. The air 21 cools the burner tip 19 during this (more on this below). The burner 11 adheres to the functional principle of a pilot burner. Said burner may, for example, be fitted in a combustion chamber of a gas turbine not depicted in greater detail, wherein the combustion chamber in this case creates a surrounding area 30 of the burner tip. A fuel lance (not shown) for the injection of another fuel may also be arranged in the air duct 21, through which fuel lance air being ejected in the conical outer surface is forced.

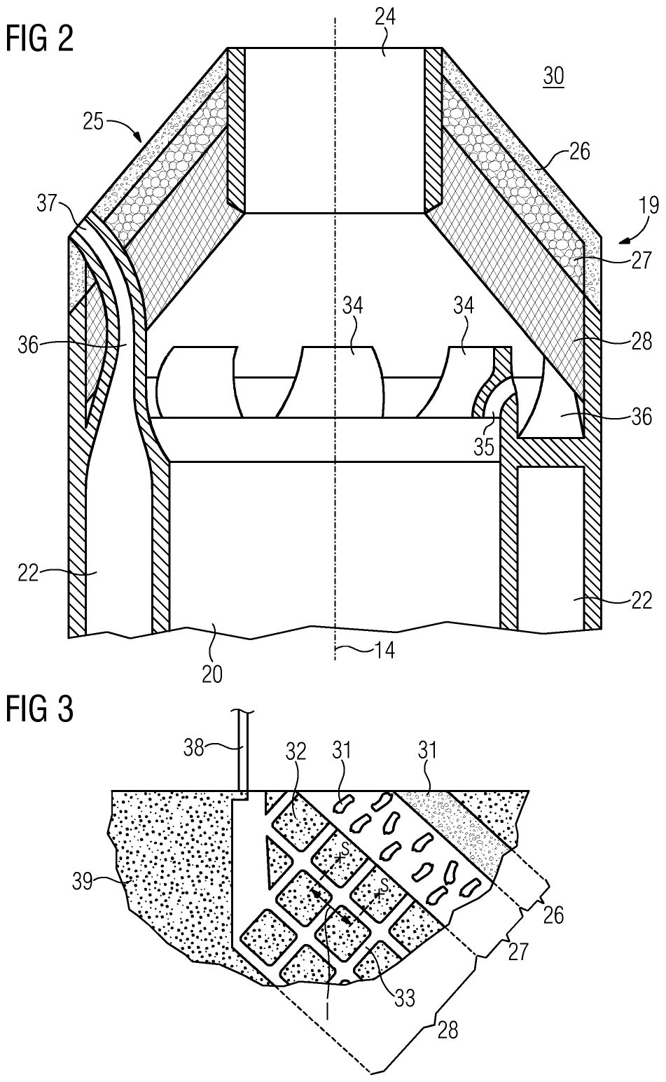

According to FIG. 2, the burner tip 19 which can be fitted in the burner 11 according to FIG. 1 is depicted in section. The central air duct 20 which opens into a central outlet opening 24 can be identified. The additional fuel lance already referred to (not shown) can be arranged in this outlet opening. Moreover, the annular channel 22 for the fuel can be identified.

The burner tip is created by a wall structure 25 which comprises a layer 26 adjacent to the surrounding area 30 of the burner tip 19, an intermediate layer 27 which may also be referred to as a center layer 27, and a layer 28 facing the central air duct 20. Each of these layers 26, 27, 28 exhibits a different structure, wherein pores 31 are provided in layer 26 and layer 27 (cf. FIG. 3) and grid gaps 32 in layer 28, said gaps being located between grid bars 33 (cf. FIG. 3).

The pores 31 and the grid gaps 32 mean that the wall structure 25 is permeable to air and therefore forms part of the air duct system. The air which is conducted through the central air duct 22 leaves the burner tip 19 partly through the outlet opening 24 and partly via the wall structure 25. Air-guiding structures 34 in the form of guide vanes are provided in the central air duct 20 which help the air to be distributed uniformly over the surface of the wall structure. Inner channels 35 in the air-guiding structures 34 also help to bring the air into the radially external peripheral area of the wall structure 25.

The layer 28 facing the central air duct 20 comprises a three-dimensional grid. Said grid has only a low flow resistance to air but gives the wall structure 25 a comparatively high mechanical stability. There are large pores in the intermediate layer 27. These also offer comparatively low flow resistance to the air but are suitable for distributing the air finely over the entire cross section of the wall structure, in other words the cross section available to the air duct structure. The layer 26 facing the surrounding area 30 exhibits smaller pores than the intermediate layer. These produce a great enlargement of the surface area inside the layer 26, so that the through-flowing air in this region is able to absorb the heat originating in the surrounding area 30 and on leaving the burner tip 19 remove it therefrom. The layer 26 is configured with a smaller thickness by comparison with the other layers, so that the flow resistance caused by it is not too great.

The annular channel 22 opens out on the periphery into a plurality of fuel channels 36 which communicate with the surrounding area 30 via fuel openings. In this way, the fuel is introduced into the surrounding area 30 in a uniformly distributed manner at the periphery of the burner tip 19, in order to avoid thermal load peaks at given points of the burner tip. Since an odd number of fuel channels 36 is arranged on the periphery, a sectional representation is produced on only one side of the burner tip 19. The same applies, moreover, to the air-guiding structures 34.

FIG. 3 shows how the burner tip 19 according to FIG. 2 can be produced in a powder bed 39 by selective laser melting by means of a laser beam 38. A detail of the wall structure 25 can be seen which comprises the layer 26 subsequently facing the surrounding area 30, the intermediate layer 27 and the layer 28 subsequently facing the air duct 20. It can be seen that pores 31 in the layer are finer than in the intermediate layer 27. This can be achieved through a modification of the laser melting process parameters, for example. The space grid in layer 28 is depicted in detail in FIG. 3. Cube-shaped grid cells result, wherein the hole spacing 1 results from the spacing of the focal points S of the cross-sectional areas of the grid gaps, in other words the point of intersection of the diagonals of the quadratic cross-sectional areas concerned.

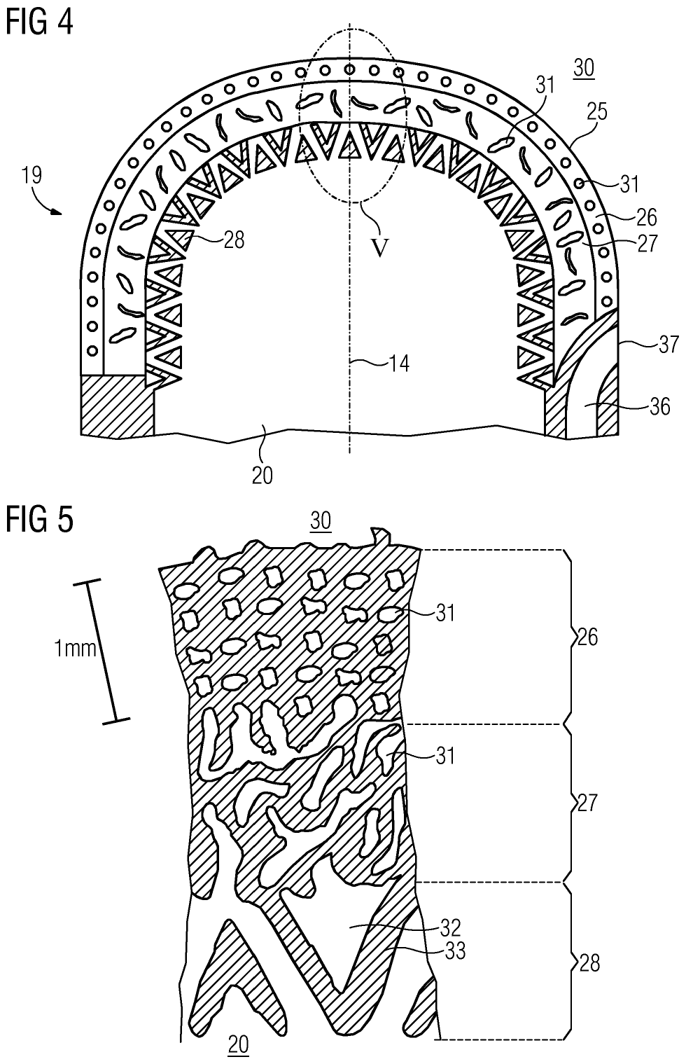

Another exemplary embodiment of the burner tip is depicted in FIG. 4. The wall structure 25 in this case has a dome-shaped form, wherein a central outlet opening 24 was dispensed with. The air completely passes through the air channel structure created by the porous wall structure, wherein the wall structure is once again configured in three layers 26, 27, 28. The fuel channel 36 also opens into the fuel opening 37, wherein said fuel opening is arranged radially outside on the burner tip 19.

The design of the wall structure 25 is depicted to scale as detail X in FIG. 5. A 1 mm length scale is drawn into FIG. 5. Each of the three layers is roughly 1 mm thick. The layer 26 facing the surrounding area 30 and the intermediate layer (center layer) 27 has pores 31, while the layer 28 facing the air channel 20 is configured as a grid structure with grid bars 33 and grid gaps 32.

The air initially passes through the layer 28, wherein the grid structure has a flow-favorable design. Through the grid gaps 32 the air reaches the rough pores 31 of the intermediate layer 27, where it is distributed with comparatively little pressure loss in the pores 31 of layer 26. From there, it reaches the surrounding area 30 in a manner not depicted in greater detail.

The grid structure in the layer 28 is geometrically configured in such a manner that it can be produced using a suitable exposure strategy, for example by means of laser melting. The pores 31 in the layers 26 and 27 in this case can be obtained by a defined exposure strategy. In this case, when the gaps between the powder particles do not produce sufficient porosity, an exposure strategy may also be used in which the surface of the powder bed 39 is only partially exposed, so that individual powder particles remain unexposed and can be moved away from the component subsequently. The center layer 27 shows a pore formation which is created by a statistically distributed, incomplete exposure of the powder bed, wherein the profile of the pores or of the exposed region of the respective powder layers is random (these correspond to an exposure stage and are substantially thinner than the three layers 26, 27, 28). The incomplete exposure regime of certain patterns follows in layer 26, for example line spacing during exposure, which is deliberately selected to be large enough for unexposed and unmelted or unsintered particles to remain between the tracks. The pores 31 are created in these areas, wherein the structure of the layer 26 is comparable with a tissue. This is achieved, for example, in that the parallel tracks are rotated through 90° at regular intervals during manufacture. Depending on the desired pore size, this change takes place after a given number of powder layers.

What is claimed is:

1. A burner tip for fitting in a burner, the burner tip comprising:
an air duct system;
a fuel channel system open to a surrounding area; and
a central air duct of the air duct system running through the burner tip surrounded by a wall structure;
wherein the wall structure comprises open pores and/or a space grid; and
open pores in the wall structure and/or gaps in the grid form a connection between the central air duct and the surrounding area of the burner tip.

2. The burner tip as claimed in claim 1, wherein the wall structure comprises multiple layers of differing porosity and/or grid structure.

3. The burner tip as claimed in claim 1, wherein the wall structure comprises three layers with differing porosity and/or grid structure.

4. The burner tip as claimed in claim 2, wherein a mean pore size in adjacent layers, viewed in the air flow direction provided, diminishes from layer to layer.

5. The burner tip as claimed in claim 1, wherein a pore size of pores in the wall structure bordering the surrounding area of the burner tip is between 10 and 250 μm.

6. The burner tip as claimed in claim 1, wherein a pore size of the open pores or a size of the gaps in the space grid in the wall structure adjacent to the central air duct is between 1 and 9 mm.

7. The burner tip as claimed in claim 6, wherein the pore size of the pores in an intermediate layer lying between an internal layer adjacent to the central air duct and an external layer bounding the surrounding area of the burner tip is between 150 and 1000 μm.

8. The burner tip as claimed in claim 1, further comprising air-guiding structures in the central air duct.

9. The burner tip as claimed in claim 8, further comprising inner channels in the air-guiding structures directed at the wall structure.

10. The burner tip as claimed in claim 1, wherein the central air duct leads to a central outlet opening in the burner tip.

11. The burner tip as claimed in claim 1, wherein the wall structure has a conical or dome-shaped form.

12. The burner tip as claimed in claim 1, further comprising a plurality of fuel channels which are part of the fuel channel system, wherein each of the plurality of fuel channels leads through the wall structure and are open to the surrounding area of the fuel tip.

13. The burner tip as claimed in claim 12, wherein the fuel channels are connected to an annular channel surrounding the central air duct.

14. A method of producing a burner tip, the method comprising:
building a burner tip with an air duct system and a fuel channel system, including a central air duct running through the burner tip surrounded by a wall structure;
using an additive manufacturing process to construct the wall structure with open pores and/or including a space grid;
wherein the burner tip in produced in a single piece.

15. The method as claimed in claim 14, wherein constructing the wall structure includes producing multiple layers of different porosity and/or a different grid structure which run in succession from the air duct system.

16. The method as claimed in claim 14, wherein:
the burner tip is manufactured in a powder bed; and
the porosity of the layers of different porosity is produced by changing the energy application in the powder bed and/or by using different powders.

17. A burner tip for fitting in a burner, the burner tip comprising:
an air duct system open to a surrounding area of the burner tip;
a fuel channel system open to the surrounding area of the burner tip; and
a central air duct running through the burner tip surrounded by a wall structure;
wherein the wall structure comprises open pores;
the burner tip is produced by an additive manufacturing process in one piece;
pores in the wall structure form part of the air duct system creating a connection between the central air duct and the surrounding area of the burner tip.

18. A burner comprising:
a burner lance; and
a burner tip at the end of the burner lance, the burner tip comprising:
an air duct system;
a fuel channel system open to a surrounding area; and
a central air duct of the air duct system running through the burner tip surrounded by a wall structure;
wherein the wall structure comprises open pores and/or a space grid; and
open pores in the wall structure and/or gaps in the grid form a connection between the central air duct and the surrounding area of the burner tip.
